(19) United States
(12) Patent Application Publication
(10) Pub. No.: US 2010/0230228 A1
(43) Pub. Date: Sep. 16, 2010

(54) DEVICE FOR FRICTIONALLY COUPLING TWO COAXIAL COMPONENTS

(76) Inventor: Jan Wernecke, Schattdorf (CH)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/738,310

(22) PCT Filed: Oct. 6, 2008
(86) PCT No.: PCT/CH08/00415

§ 371 Date: May 7, 2010

(30) Foreign Application Priority Data
Oct. 17, 2007 (EP) 07118725.6

(51) Int. Cl. F16D 1/091; F16D 25/00

(52) U.S. Cl. 192/66.2; 192/85.01

(57) ABSTRACT

The invention relates to a device (1) for frictionally coupling two coaxial components (4, 5, 41, 42), especially two shafts (41, 42) or a shaft (4) and a hub (5). Said device comprises a first, inner coupling element (2) having a conical, peripheral surface (22) and a second, outer coupling element (3) having a conical, inner peripheral surface (32, 52). The two coupling elements (2, 3) are suitable to be reversibly slid one onto the other in the direction of a longitudinal axis (11), thereby being elastically deformed in the radial direction in such a manner that the conical peripheral surfaces (22, 32, 52) come to rest one on another, and the two coaxial components (4, 5, 41, 42) are frictionally interconnected via the coupling elements (2, 3) owing to the radial forces caused by the elastic deformation of the coupling elements (2, 3). The device also comprises a hydraulic tool (6) which is capable of exerting an axial force on the second coupling element (3) in the direction of the increasing circumference of the peripheral surface (22) of the first coupling element (2). Hydraulic means (34, 54, 66′, 68, 58, 38) can be used to produce an oil-filled gap between the two peripheral surfaces (22, 32), said gap allowing the two coupling elements (2, 3) to be displaced with little friction. The device finally comprises securing means (7) which can be used to adjust a maximum possible position of displacement of the second coupling element (3, 31, 5) in the direction of the increasing circumference of the peripheral surface (22) of the first coupling element (2) so as to avoid an unintentional, uncontrolled slipping of the outer coupling element (3) from the end position when the oil gap pressure is modified during assembly or disassembly.

### TECHNICAL FIELD

The invention relates to a device for frictionally coupling two coaxial components according to the preamble of the independent patent claim as well as a method for assembly and disassembly of such a device.

### PRIOR ART

Various possibilities are known for the torsion-proof connection of two coaxial components, for example, of two shafts or a shaft and a hub. In order to enable simple and rapid assembly, maintenance and disassembly, such connections must additionally be non-destructively detachable.

Inter alia, frictional connections by means of a conical oil press fit are widely used. In this connection, for example, a hub having a conical inner bore is pressed onto a shaft having a conical peripheral surface, oil being pressed into the intermediate gap, causing the outer piece to be elastically enlarged so that it can be pushed onto the inner cone. After reaching the desired position, the oil pressure in the gap is released, with the result that the outer piece contracts and fits onto the inner piece. As a result of the persistent elastic deformation of the outer piece, a contact pressure results between the contact surfaces of the inner piece and the outer piece. The maximum torque which can be transmitted with such an oil press fit is proportional to this contact pressure, the contact area and the coefficient of static friction between the surfaces.

The manufacture of shafts having conical pins and hubs having a conical inner bore is complex and expensive and in the event of faulty manufacture, the entire, in some cases very large and heavy component can become unusable. In addition, the components to be connected are frequently supplied by different manufacturers, which requires precise coordination. It is therefore frequently more cost-effective to provide both components with cylindrical inner or outer surfaces and to connect these by means of a corresponding oil press fit coupling device. Such a device consists of an inner sleeve comprising a cylindrical inner casing and a conical outer casing, and an outer sleeve comprising a conical inner casing and a cylindrical outer casing. The outer sleeve is then pressed onto the inner sleeve with the result that a frictional connection is formed on the one hand between both sleeve parts and on the other hand between inner sleeve and shaft or outer sleeve and hub. If appropriate, only the inner or the outer sleeve is used, which then cooperates directly with the cone surface of the outer component. Similarly, a coupling device comprising inner and outer sleeves is also used for frictional connection of two coaxial shafts having cylindrical pins, the inner sleeve being disposed above the opposing shaft ends so that after pressing on the outer sleeve, the two shafts are frictionally connected to the coupling device and therefore to one another. Conical oil press fit couplings of the aforesaid types are supplied, for example, by Voith Turbo, Heidenheim, Germany under the designation “Hycon”.

The pressing of the conical hub or the outer sleeve onto the conical inner piece is preferably accomplished by means of a hydraulic tool, which can push or pull the outer conical part in the direction of increasing circumference onto the inner cone. In order to expand the outer component and optionally the outer sleeve, oil is pressed hydraulically into the conical gap so that the two conical surfaces no longer rest one upon the other. The corresponding oil clearance pressure results in an axial force in the direction of decreasing circumference of the inner cone. This is the product of oil clearance pressure and projection of the conical peripheral surface along the longitudinal direction. Such a hydraulic tool is disclosed, for example, in EP 1775490 A1 in which a hydraulic nut is screwed onto a shaft and a roller bearing is pressed onto a conical shaft end by means of a pressurised ring piston.

Systems are also known in which the hydraulic tool is integrated in the coupling device. For example, SKF Coupling Systems AB, Hofors, Sweden supplies such a coupling device under the designation “OKC” and “OKF”. This consists of a conical inner sleeve, conical outer sleeve and a ring piston which is connected to the inner sleeve at the outer end and forms a hydraulic chamber together with the outer sleeve.

For explanation, FIG. 1 shows a sectional view of a coupling device as is known from the prior art. For pressing a hub 5 onto a shaft 4, a first inner coupling element 2 in the form of an inner sleeve is disposed in a second outer coupling element 3 in the form of an outer sleeve 31 and these are connected positively to the hydraulic tool 6 by means of screws 67. Disposed in the hydraulic tool 6 is a ring piston 62 having a seal 63 which is still located in the retracted position. Ring piston 62 and the body of the hydraulic tool 6 form an annular hydraulic chamber 61. The ring piston 62 rests on the inner sleeve 21. For assembly the hub 5 is brought onto the outer sleeve 31 and the shaft 4 is inserted into the inner sleeve 21. The hydraulic chamber 62 is now pressurised with a pressure pₐₓ via a hydraulic supply line 69″ whereby a force acting axially to the left is produced on the hydraulic tool 6 and therefore on the outer sleeve 31. A helical distributor groove 34 on the conical inner surface 33 of the outer sleeve 31 is then subjected to a pressure pₛₚ via a second hydraulic supply line 69′ and hydraulic line 68, 38 so that an oil clearance is formed between the conical surfaces 22, 32 and the outer sleeve 31 together with the hub 5 is elastically expanded. The outer sleeve 31 now floats on the inner sleeve 21 and is displaced to the left as a result of the leftwardly acting tensile force of the hydraulic tool until the tensile force and the counteracting force correspond as a result of the oil clearance. The two hydraulic pressures pₐₓ and pₛₚ are now alternately increased until the hub 5 has reached the desired end position. The oil clearance pressure is finally released with the result that the outer sleeve 31 contracts and sits on the inner sleeve 21. After a certain waiting time, the gap between the conical surfaces 22, 32 is oil-free and the axial hydraulic pressure is released. This results in a frictional press fit of the hub 5 and the two sleeves 31, 21 on the shaft 4. The hydraulic tool 6 can then be removed. Disassembly proceeds substantially in the reverse manner.

In the known conical oil press fit coupling devices, it can occur when releasing the oil clearance pressure after reaching the end position that as a result of the decreasing axial force of the oil clearance pressure whilst the tensile force remains constant, the sleeve 31 slips abruptly to the left once again which, on the one hand, can result in the tolerances for the elongation of outer sleeve 31 and hub 5 being exceeded and on the other hand, can lead to a non-perpendicular uncontrolled placement of the conical surfaces 22, 32 onto one another, which can cause damage to the surfaces. At the same time, scratches can be formed which increase the leaks at the gap ends, which can even have the result that the necessary oil clearance pressure can no longer be achieved for a subsequent disassembly. In such a case, the coupling device can no longer be detached in a non-destructive manner. The same problem can also arise during the disassembly of a coupling device, wherein the outer sleeve 31 can slip in both directions when increasing the oil clearance pressure depending on whether the force of the hydraulic tool is too large or too small.

Since in the case of irregularly formed outer parts, in particular in the case of hubs 5, the radial elasticity is not identical over the length, it can be that the oil clearance becomes irregularly thick as a result of the different pressing forces. In such cases, peripheral seals 35′, 35″ are advantageously arranged at both ends of the outer sleeve 31 in order to minimise the leakage at the gap ends and thus achieve a higher oil clearance pressure.

In other known conical oil press fit coupling devices, the inner sleeve 21 is coated to increase the coefficient of static friction, whereby an increase in the coefficient of static friction from μ=0.14 (steel/steel) or μ=0.18 (steel/steel degreased) to μ=0.3 is possible. This improved value allows the transmission of greater torques or the smaller design of coupling devices. When pressing-on the outer sleeve and in particular during an abrupt slippage when releasing the oil pressure, as has been described above, the special coating can destroy the seals 35′, 35″ consisting of plastic. Increasing the coefficient of static friction is therefore not very compatible with the use of seals to increase the maximum oil clearance pressure.

### DESCRIPTION OF THE INVENTION

It is the object of the invention to provide a device for frictionally coupling two coaxial components which does not have the aforesaid disadvantages and in particular allows secure assembly and disassembly of the coupling device without abrupt slippage of the outer sleeve. A method for the secure assembly and disassembly of such a coupling is also to be provided as well as a hydraulic tool and a coupling for use in a device according to the invention.

These and other objects are achieved by a device according to the invention, a hydraulic tool according to the invention, a coupling according to the invention and a method according to the invention according to the independent claims. Further preferred embodiments are given in the dependent claims.

In a device according to the invention, abrupt slippage is prevented by providing securing means which adjustably specify a maximum displacement end position of the outer coupling element in the direction of the increasing cone circumference of the inner coupling coupling element or fix the desired end position of the outer coupling element after this has been reached. These securing means can be configured in various ways as will be explained hereinafter. They can be arranged, for example, on the hydraulic tool or at the end of the coupling device opposite the hydraulic tool.

### BRIEF DESCRIPTION OF THE DRAWINGS

The device according to the invention is explained hereinafter with reference to drawings.

FIG. 1 shows a sectional view of a coupling device according to the prior art.

FIGS. 2, 4 and 6 show sectional views of possible embodiments of a device according to the invention in which two sleeves are provided.

FIGS. 3, 5 and 7 show possible embodiments of a device according to the invention by analogy with FIGS. 2, 4 and 6 in which the hub has a conical inner peripheral surface.

FIGS. 8 and 9 show two possible embodiments of a device according to the invention for coupling two coaxial shafts.

FIG. 10 shows a possible embodiment of an outer and inner sleeve of a device according to the invention having static-friction-enhancing coatings.

### EXECUTION OF THE INVENTION

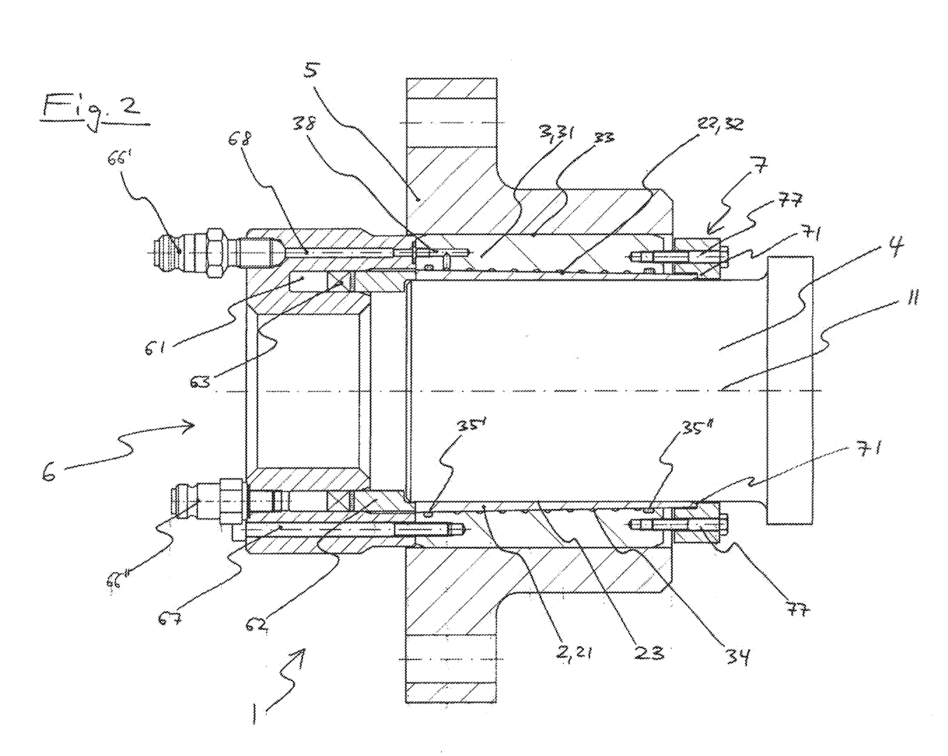

FIG. 2 shows in sectional view a possible embodiment of a coupling device 1 according to the invention which in the example shown frictionally connects a shaft 4 and a hub 5.

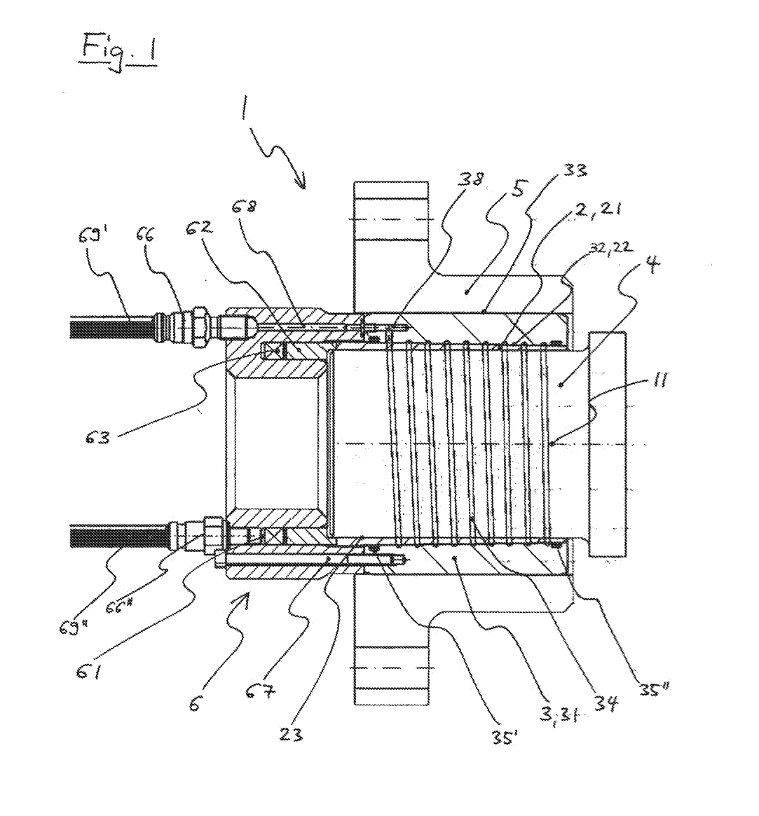

A first inner coupling element 2 in the form of a sleeve 21 having a cylindrical inner surface 23 and a conical outer peripheral surface 22 is disposed on the shaft 4. In turn, a second outer coupling element 3 in the form of a sleeve 31 having a conical inner peripheral surface 32 and a cylindrical outer surface 33 is disposed on the inner sleeve 21. Finally, the hub 5, which is a flanged hub here, is disposed on the outer sleeve 31. A hydraulic tool 6, i.e. a hydraulic nut, is positively connected to the outer sleeve 31 by means of connecting elements 67, i.e. a plurality of screws 67, and is capable of exerting a tensile force acting to the left in the longitudinal direction on the outer sleeve 31. The individual elements of the device 1 shown correspond to those of the device from FIG. 1, reference being made herewith to the relevant explanations.

In the device 1 in FIG. 2, the outer sleeve 31 is in the end position in which it is intended to remain after releasing the oil clearance pressure. In order to prevent the outer sleeve from unintentionally slipping further to the left in this case, pulled by the hydraulic tool 6m a securing means 7 is provided. In the example shown, this is a ring 7 disposed on the shaft 4 which is supported with a peripheral shoulder as a stop element 71 on a terminal edge of the inner sleeve 21. The ring 7 is positively connected to the outer sleeve 31 by means of connecting means in the form of a plurality of screws 77.

During the assembly itself, the securing means 7 is not connected to the outer sleeve 31. After reaching the end position of the outer sleeve 31 and the hub 5, the ring is pushed to the left until it is present at the inner sleeve 21. The screws 77 are then inserted through holes in the ring and screwed into corresponding threaded holes of the outer sleeve 31 and gently tightened until there is no longer any play between ring 7 and inner sleeve 21. The oil clearance pressure pₛₚ can then be uniformly reduced to zero. Although the rightwardly acting force of the oil clearance pressure now becomes smaller with the force to the left, the outer sleeve can no longer slip to the left because this is prevented by the securing means 7.

After a waiting time in which the oil can flow completely out from the conical gap, the hydraulic pressure pₐₓ can be released and the hydraulic tool 6 removed. The securing means 7 preferably remains in place. It can, however, be composed of two or more segments so that it can be removed again after assembly.

During disassembly of the device 1 according to the invention, the hydraulic tool 6 and, if still present, the securing means 7 is positively fastened to the outer sleeve 41. The hydraulic pressure of the tool 6 pₐₓ is then raised to a maximum value p_{ax,2}, this pressure preferably being higher than the highest axial pressure p_{ax, 1} during assembly. The tensile force thus produced is initially absorbed by the static friction between the sleeves 21, 31. The oil clearance pressure is then increased to a value p_{sp,1} at which a sufficient oil clearance is produced. The tensile force is now absorbed by the securing element 7 and slippage of the sleeve 31 to the left is thus rendered impossible by the securing means 7. Slippage to the right is in turn prevented by the strong axial tensile force of the hydraulic tool 6, in which case the tensile force must naturally be larger than the force of the oil clearance pressure. The hydraulic pressure pₐₓ can then be slowly reduced. If the tensile force now becomes smaller than the oppositely directed force of the oil clearance pressure, the outer sleeve 31 begins to move towards the right as far as a disassembly position. Since an oil clearance is provided in this case from the very beginning, no damage can occur.

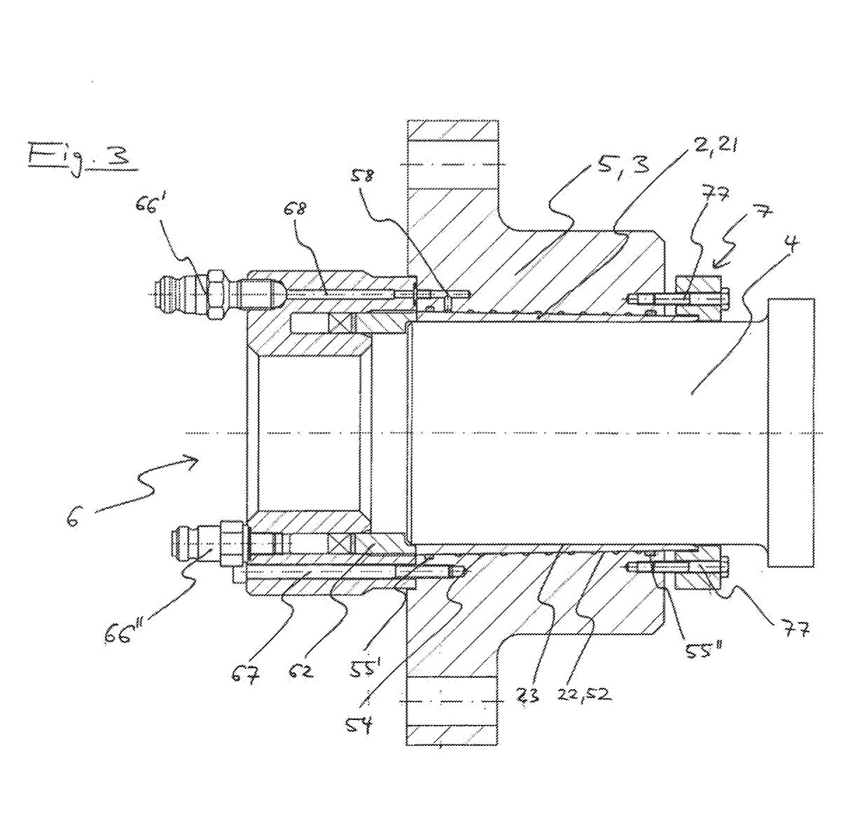

FIG. 3 shows a device 1 according to the invention which substantially corresponds to the device from FIG. 2. In the example shown, however, no outer sleeve is provided but the hub 5 itself is the outer coupling element 3 and has a conical inner peripheral surface 52, with distributor groove 54, hydraulic line 58 and seals 55′, 55″.

Naturally, a device according to the invention can also be achieved similarly with a shaft having a conical pin, wherein this conical pin itself is then the inner coupling element 2.

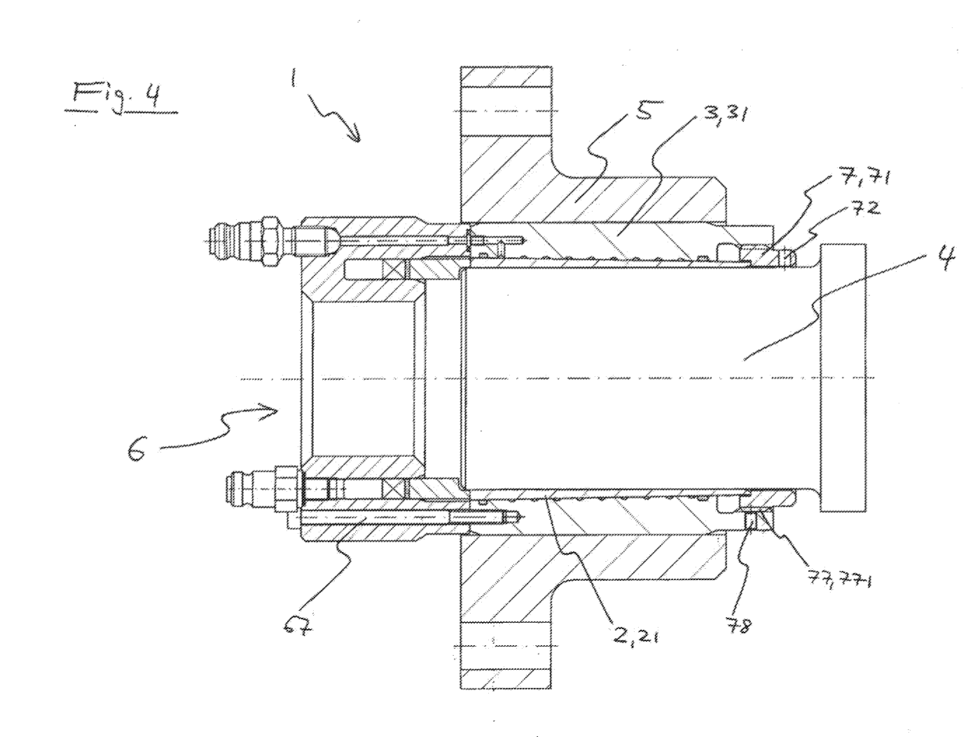

FIG. 4 shows another possible embodiment of a coupling device according to the invention which is constructed similarly to that from FIG. 2. In this case, however, the securing means is a securing ring 7 which is provided with an external thread 771 which engages in a corresponding internal thread of the outer sleeve 31. The ring 7 in turn has a peripheral shoulder 71 which rests on the terminal edge of the inner sleeve 21. The dimensioning of the securing ring 7 should be selected so that it can easily be turned both in the initial position and in the end position and in particular does not stick on the shaft 4. For actuating the securing ring 7, the example shown has radial holes 72 by which means the ring can be turned with a pin or hook wrench. Alternatively, axially running grooves, front-side axial holes or front-side radial grooves can also be used.

Operation is accomplished similarly to the embodiments already discussed. Before releasing the oil clearance hydraulic pressure at the end of the assembly process or before building up the axial hydraulic pressure of the hydraulic tool 6 and the oil clearance hydraulic pressure during disassembly, the securing ring 7 is screwed into the internal thread of the outer sleeve 31 until the shoulder 71 rests on the edge of the inner sleeve 21. The outer sleeve 31 can now not be pushed any further to the left onto the inner sleeve 21. After assembly, the securing ring 7 preferably remains in place. In order to prevent the securing ring coming loose during turning of the shaft, for this purpose a threaded bolt 78 is provided in a corresponding radial hole in the outer sleeve 31, this bolt being screwed onto the external thread 771 and thus fixes the securing ring 7.

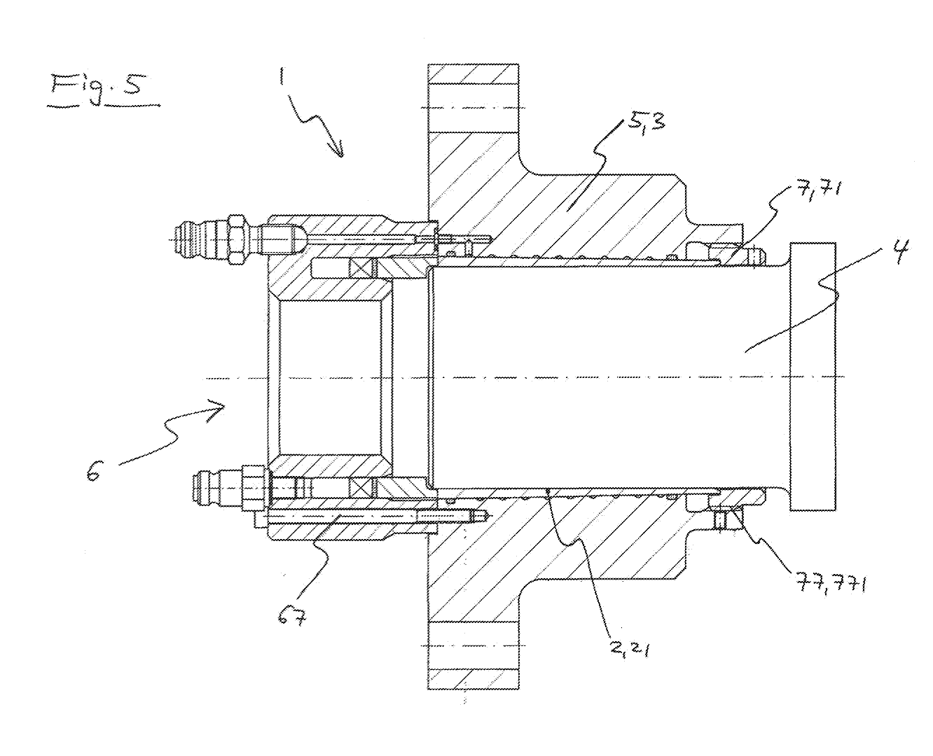

FIG. 5 shows the device from FIG. 4 with a conical hub 5 instead of an outer sleeve 31 as outer coupling element 3.

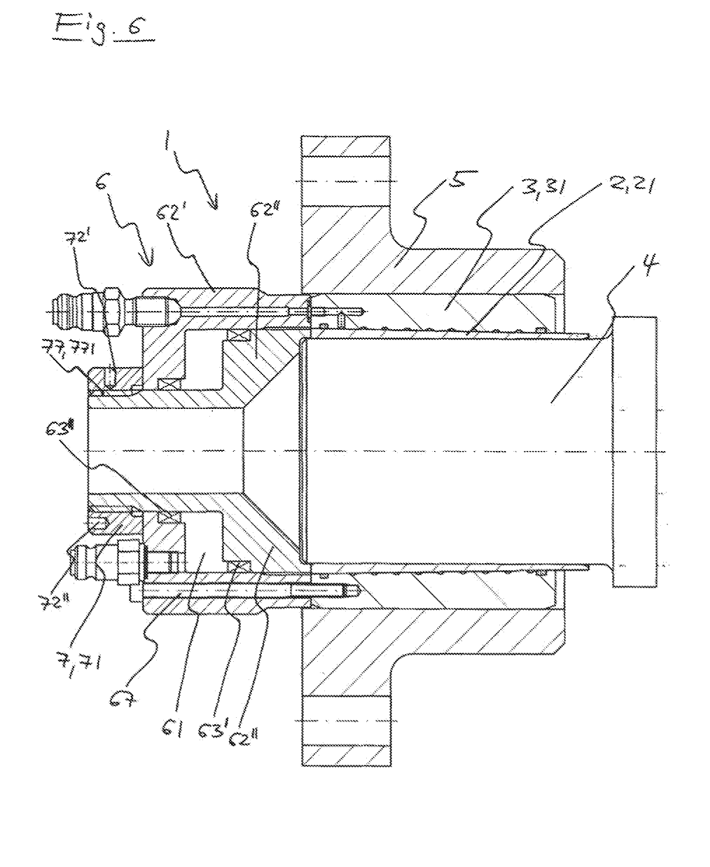

FIG. 6 shows another variant of a device 1 according to the invention in which the securing means 7 is disposed on the hydraulic tool 6. This substantially consists of two parts 62′, 6212 which form an annular hydraulic chamber 61. The inner part 62″ is supported on the inner sleeve 21 whilst the outer part 62′ is positively connected to the outer sleeve 31 by means of screws 67. At its end facing away from the shaft 4, the inner part 62″ has an external thread or an interrupted helical bayonet profile 771. After reaching the end position of the outer sleeve 31, the securing means in the form of a securing nut 7 can be applied to this and turned flush onto the outer part 62′ so that a further displacement of the outer part 62′ to the left with respect to the inner part 62″ and therefore of the outer sleeve 31 with respect to the inner sleeve 21 is no longer possible. For actuating, the securing nut 7 can be provided with radial 72′ or axial 72″ holes.

This variant has the particular advantage that the outer sleeve 31 can be constructed more simply, in particular without axial holes or internal threads and that no securing means 7 remains on the assembled coupling device 1 but remains on the removable hydraulic tool 6 which can be used many times, which reduces the manufacturing costs.

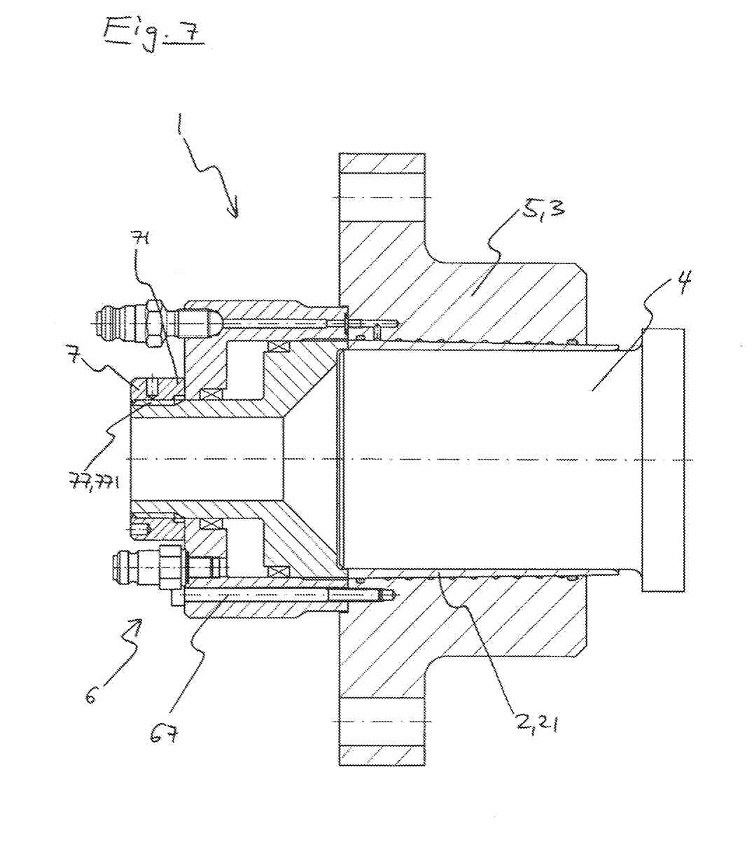

FIG. 7 in turn shows the device from FIG. 6 with a conical hub 3 as outer coupling element 3.

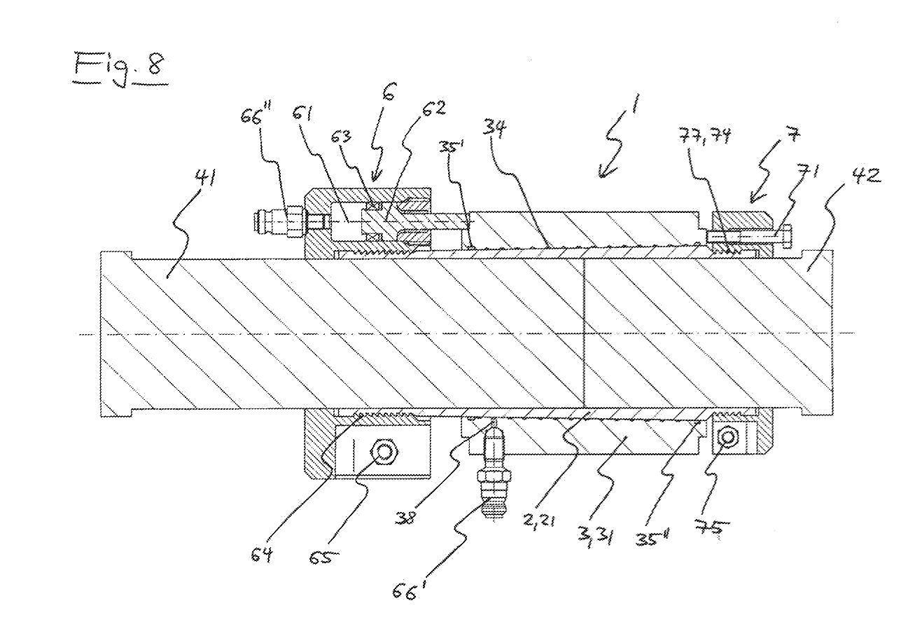

FIG. 8 shows a coupling element 1 according to the invention for connecting two coaxial shafts 41, 42. The hydraulic tool 6 is configured as multi-part and is assembled around the first shaft 41, the individual parts being connected by means of connecting elements 65, in particular screw connections. The hydraulic tool 6 is positively connected to the inner sleeve 21, in the example shown by means of a sawtooth profile 64. Alternatively, a thread or another suitable fastening method can naturally also be used for this purpose. In the example shown, the outer sleeve 31 is pushed to the right onto the inner sleeve 21, by means of a plurality of pressure-interconnected hydraulic cylinders 61 which actuate pistons 62 resting on the outer sleeve 31 and thus produce an axial thrust force to the right. At the opposite end of the inner sleeve 21 there is disposed a securing means in the form of a likewise multipart securing ring 7 which is connected to the inner sleeve 21 by means of a sawtooth profile 74. After reaching the end position of the outer sleeve 31, screws 71 are screwed into corresponding axial holes of the securing ring 7 until they rest against the outer sleeve 31 and thus prevent any further slippage of the sleeve to the right. After completing assembly, both the hydraulic tool 6 and also the securing means 7 can be removed and used for the assembly of further couplings.

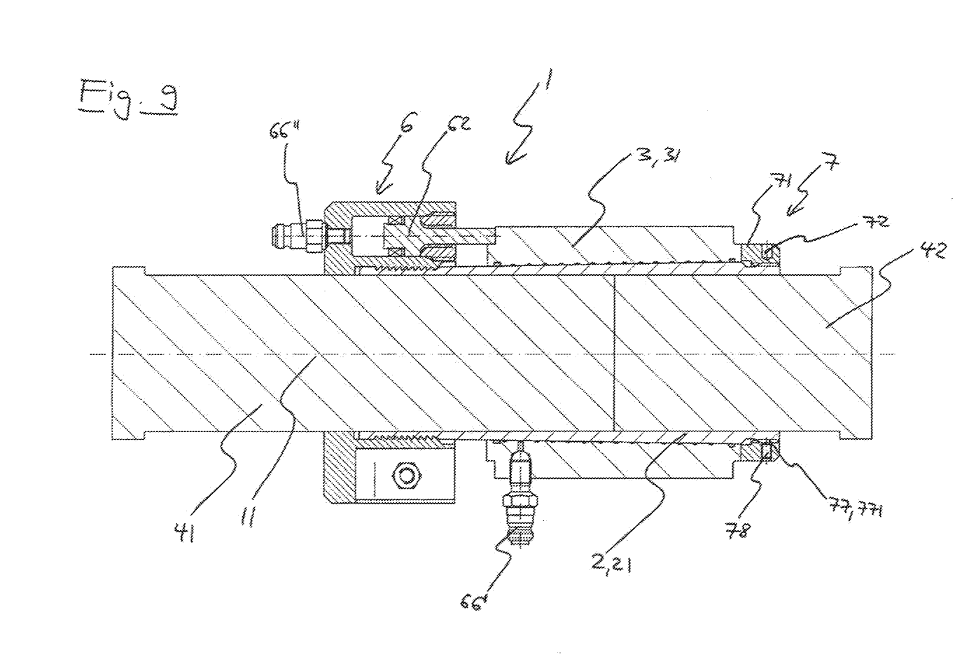

FIG. 9 likewise shows a coupling element 1 according to the invention for the connection of two coaxial shafts 41, 42 similarly to FIG. 8. In this case, however, the securing means is designed as a one-piece lock nut 7 which is screwed onto a corresponding external thread 771 of the inner sleeve 21 until it rests against the outer sleeve 31 and thus positively makes any further slippage of the outer sleeve 31 to the right impossible. In this variant the securing means 7 remains in place after assembly and is secured against coming loose by means of a threaded bolt 78.

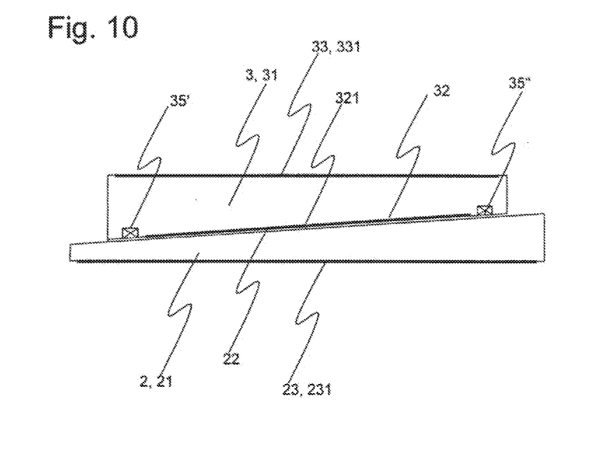

FIG. 10 shows an embodiment of an outer sleeve 31 and inner sleeve 21 of a device according to the invention having a static-friction-enhancing coating 321 of the inner peripheral surface. The inner peripheral surface 32 of the outer sleeve 31 has two seals 35′, 35″ which are disposed on the two longitudinal side ends. Between the two seals the peripheral surface 32 is provided with a coating 321 which enhances the static friction between peripheral surface 32 of the outer sleeve 31 and the peripheral surface 22 of the inner sleeve 21. Suitable, for example, is a coating with hard metal particles by means of flame spraying in which the metal parts are not thermally stressed. The outer conical peripheral surface 22 of the inner sleeve 21 is not coated. Coefficients of static friction of μ=0.5-0.7 can thus be achieved. Such an arrangement additionally has the advantage that in the event of an accidental slippage of the sleeve parts with respect to one another, in particular during the release or decrease of the oil clearance pressure during assembly or disassembly, the seals 35′, 35″ can never come in contact with the static-friction-enhancing rough coating 321 and thereby be damaged. In order to further increase the static friction, the cylindrical surfaces 23, 33 of the sleeves 21, 31 can also be provided with corresponding coatings 231, 331, in which case the entire surface can be coated here since no transverse displacement under pressing pressure takes place and should take place between the cylindrical surfaces 23, 33 and the components 4, 5 to be coupled.

### REFERENCE LIST

1 Coupling device
11 Axis of rotation
2 First inner coupling element
21 Inner sleeve
22 Conical outer peripheral surface
23 Cylindrical inner surface
231 Static-friction-enhancing coating
3 Second outer coupling element
31 Outer sleeve
32 Conical inner peripheral surface
321 Static-friction-enhancing coating
33 Cylindrical outer surface
331 Static-friction-enhancing coating
34 Distribution groove
35′, 35″ Seal
38 Hydraulic line
4 Shaft
41 First shaft
42 Second shaft
5 Hub
52 Conical inner peripheral surface
54 Distribution groove
55′, 55″ Seal
58 Hydraulic line
6 Hydraulic tool
61 Hydraulic chamber
62, 62′, 62″ Piston element
63, 63′, 63″ Seal
64 Sawtooth profile
65 Connecting means
66′, 66″ Hydraulic connection
67 Connecting means
68 Hydraulic line
69′, 69″ Supply line
7 Securing means

71 Stop element
72, 72′, 72″ Hole
74 Sawtooth profile
75 Connecting means
77 Connecting means
771 Thread
78 Threaded bolt

1. A device (1) for frictionally coupling two coaxial components (4, 5, 41, 42), in particular two shafts (41, 42) or a shaft (4) and a hub (5), comprising a first inner coupling element (2) having a conical outer peripheral surface (22) and a second outer coupling element (3) having a conical inner peripheral surface (32, 52), wherein the two coupling elements (2, 3) are suitable to be reversibly slid one onto the other in the direction of a longitudinal axis (11) and thereby being elastically deformed in the radial direction in such a manner that the conical peripheral surfaces (22, 32, 52) come to rest one on another and the two coaxial components (4, 5, 41, 42) are frictionally interconnected via the coupling elements (2, 3) owing to the radial forces caused by the elastic deformation of the coupling elements (2, 3); a hydraulic tool (6) having means (61, 62, 62′, 62″) which can produce an axial force acting on the second coupling element (3) in the direction of increasing circumference of the peripheral surface (22); and hydraulic means (34, 54, 66′, 68, 58, 38) which can produce an oil-filled clearance between the two peripheral surfaces (22, 32), said clearance allowing the two coupling elements (2, 3) to be displaced with little friction; by wherein securing means (7) can be used to adjust a maximum possible displacement position of the second coupling element (3, 31, 5) in the direction of the increasing circumference of the peripheral surface (22) of the first coupling element (2).

2. The device according to claim 1, wherein the second coupling element (3, 31, 5) can be fixed positively in the direction of increasing circumference of the peripheral surface (22) of the first coupling element (2) by means of the securing means (7).

3. The device according to claim 1, wherein the securing means (7) cooperate with the hydraulic tool (6) in such a manner that a part (62′) of the hydraulic tool (6) connected to the second coupling element (3, 31, 5) can be fixed positively in the direction of increasing circumference of the peripheral surface (22) of the first coupling element (2).

4. The device according to claim 1, wherein the outer coupling element (3) has at least one peripheral seal (35′, 35″) at each of its two longitudinal ends on the conical peripheral surface (32) and the corresponding interposed peripheral surface (32) is provided with a coating (321) which enhances the coefficient of static friction.

5. The device according to claim 1, wherein a cylindrical inner surface (23) of the first coupling element (2, 21) and/or a cylindrical outer surface (33) of the second coupling element (3, 31) is provided with a coating (231, 331) which enhances the coefficient of static friction.

6. The device according to claim 4, wherein the coatings (321, 231, 331) which enhance the coefficient of static friction consist of hard metal particles applied by means of flame spraying.

7. A hydraulic tool (6) for use in a device (1) according to claim 1, comprising means (61, 62, 62′, 62″) which can produce an axial force acting on a second outer coupling element (3) in the direction of increasing circumference of the outer conical peripheral surface (22) of a first inner coupling element (2), wherein securing means (7) can be used to adjust a maximum possible displacement position of the second coupling element (3, 31, 5) in the direction of the increasing circumference of the peripheral surface (22) of the first coupling element (2), wherein the securing means (7) cooperate with the hydraulic tool (6) in such a manner that a part (62′) of the hydraulic tool (6) to be connected to the second coupling element (3, 31, 5) can be fixed positively in the direction of the increasing circumference of the peripheral surface (22) of the first coupling element (2).

8. A coupling for use in a device (1) according to claim 1, comprising a first inner coupling element (2) having a conical outer peripheral surface (22) and a second outer coupling element (3) having a conical inner peripheral surface (32, 52), wherein the two coupling elements (2, 3) are suitable to be reversibly slid one onto the other in the direction of a longitudinal axis (11) and thereby being elastically deformed in the radial direction in such a manner that the conical peripheral surfaces (22, 32, 52) come to rest one on another and the two coaxial components (4, 5, 41, 42) are frictionally interconnected via the coupling elements (2, 3) owing to the radial forces caused by the elastic deformation of the coupling elements (2, 3), wherein securing means (7) can be used to adjust a maximum possible displacement position of the second coupling element (3, 31, 5) in the direction of the increasing circumference of the peripheral surface (22) of the first coupling element (2), wherein the second coupling element (3, 31, 5) can be fixed positively in the direction of the increasing circumference of the peripheral surface (22) of the first coupling element (2) by means of the securing means (7).

9. The coupling according to claim 8, wherein the outer coupling element (3) has at least one peripheral seal (35′, 35″) at each of its two longitudinal ends on the conical peripheral surface (32) and the corresponding interposed peripheral surface (32) is provided with a coating (321) which enhances the coefficient of static friction.

10. The coupling according to claim 8, wherein a cylindrical inner surface (23) of the first coupling element (2, 21) and/or a cylindrical outer surface (33) of the second coupling element (3, 31) is provided with a coating (231, 331) which enhances the coefficient of static friction.

11. The coupling according to claim 9, wherein the coatings (321, 231, 331) which enhance the coefficient of static friction consist of hard metal particles applied by means of flame spraying.

12. A method for coupling two coaxial components (4, 5, 41, 42), in particular two shafts (41, 42) or a shaft (4) and a hub (5) with a device (1) according to claim 1, comprising the steps:
preparing the two components (4, 5, 41, 42) and the device (1) in an initial position;
alternate stepwise increase of the axial hydraulic pressure pₐₓ and the oil-clearance hydraulic pressure pₛₚ to p_{ax,1} or p_{sp,1} until the second coupling element (3) has reached the desired end position;
attaching the securing means (7) so that a further displacement of the second coupling element (3) in the direction of the increasing circumference of the peripheral surface (22) of the first coupling element (2) is no longer possible;
reducing the oil-clearance hydraulic pressure pₛₚ to 0;
reducing the axial hydraulic pressure pₐₓ to 0.

13. The method according to claim 12, wherein before reducing the oil-clearance hydraulic pressure pₛₚ, the axial hydraulic pressure pₐₓ is increased to a value p_{ax,2}>p_{ax,1}.

14. A method for decoupling two coaxial components (4, 5, 41, 42), in particular two shafts (41, 42) or a shaft (4) and a hub (5) with a device (1) according to claim 1, comprising the steps:
preparing the hydraulic tool (6);
attaching the securing means (7) so that a further displacement of the second coupling element (3) in the direction of the increasing circumference of the peripheral surface (22) of the first coupling element (2) is no longer possible;
increasing the axial hydraulic pressure pₐₓ to p_{ax,2};
increasing the oil-clearance hydraulic pressure pₛₚ to a value p_{sp,1} at which an axial thrust or tensile force of the hydraulic tool is greater than an opposed force resulting from the oil clearance pressure;
alternate stepwise reduction of the axial hydraulic pressure pₐₓ and the oil-clearance hydraulic pressure pₛₚ until the second coupling element (3) has reached the desired end position;
reducing the oil-clearance hydraulic pressure pₛₚ and the axial hydraulic pressure pₐₓ to 0.

15. A device (1) for frictionally coupling two coaxial components (4, 5, 41, 42), in particular two shafts (41, 42) or a shaft (4) and a hub (5), comprising a first inner coupling element (2) having a conical outer peripheral surface (22) and a second outer coupling element (3) having a conical inner peripheral surface (32, 52), wherein the two coupling elements (2, 3) are suitable to be reversibly slid one onto the other in the direction of a longitudinal axis (11) and thereby being elastically deformed in the radial direction in such a manner that the conical peripheral surfaces (22, 32, 52) come to rest one on another and the two coaxial components (4, 5, 41, 42) are frictionally interconnected via the coupling elements (2, 3) owing to the radial forces caused by the elastic deformation of the coupling elements (2, 3), wherein the outer coupling element (3) has at least one peripheral seal (35′, 35″) at each of its two longitudinal ends on the conical peripheral surface (32) and the corresponding interposed peripheral surface (32) is provided with a coating (321) which enhances the coefficient of static friction.

16. The device according to claim 15, wherein a cylindrical inner surface (23) of a first coupling element (2, 21) and/or a cylindrical outer surface (33) of a second coupling element (3, 31) is provided with a coating (231, 331) which enhances the coefficient of static friction.

17. The device according to claim 15, wherein the coatings (321, 231, 331) which enhance the coefficient of static friction consist of hard metal particles applied by means of flame spraying.

18. The device according to claim 15, wherein a hydraulic tool (6) comprising means (61, 62, 62′, 62″) which can produce an axial force acting on the second coupling element (3) in the direction of increasing circumference of the peripheral surface (22) of the first coupling element (2) and hydraulic means (34, 54, 66′, 68, 58, 38) which can produce an oil-filled clearance between the two peripheral surfaces (22, 32), said clearance allowing the two coupling elements (2, 3) to be displaced with little friction.

19. The device according to claim 18, wherein securing means (7) can be used to adjust a maximum possible displacement position of the second coupling element (3, 31, 5) in the direction of the increasing circumference of the peripheral surface (22) of the first coupling element (2).

20. The device according to claim 19, wherein the second coupling element (3, 31, 5) can be fixed positively in the direction of the increasing circumference of the peripheral surface (22) of the first coupling element (2) by means of the securing means (7).

21. The device according to claim 19, wherein the securing means (7) cooperate with the hydraulic tool (6) in such a manner that a part (62′) of the hydraulic tool (6) which can be connected to the second coupling element (3, 31, 5) can be fixed positively in the direction of increasing circumference of the peripheral surface (22) of the first coupling element (2).
